(19) United States
(12) Patent Application Publication
(10) Pub. No.: US 2026/0144698 A1
(43) Pub. Date: May 28, 2026

(54) APPARELS FOR FACILITATING A LYMPHATIC THERAPY IN RELATION TO A USER BODY

(71) Applicant: Lauren Alicia Scott, Dover Heights (AU)

(72) Inventor: Lauren Alicia Scott, Dover Heights (AU)

(21) Appl. No.: 19/178,535

(22) Filed: Apr. 14, 2025

Related U.S. Application Data
(60) Provisional application No. 63/634,304, filed on Apr. 15, 2024.

(51) Int. Cl. A61H 7/00

(52) U.S. Cl. CPC A61H 7/001; A61H 2201/10; A61H 2201/165; A61H 2209/00; A61H 2230/25

(57) ABSTRACT

The present disclosure provides an apparel for facilitating a lymphatic therapy in relation to a user body. Further, the apparel may include an apparel layer which may be configured to be positioned on the user body associated with a user. Further, the apparel layer includes a compression layer which may be configured for facilitating a compression of the apparel in relation to the user body. Further, the compression results in the lymphatic therapy in relation to a lymphatic system comprised in the user body. Further, the compression layer further includes a three dimensional pattern which may be configured for facilitating a nano-massage associated with the user body. Further, the nano-massage corresponds to a micro-level stimulation of the user body. Further, the lymphatic therapy may be further based on the nano massage.

### FIELD OF DISCLOSURE

The present invention relates to the field of wearable therapeutic garments and accessories. More specifically, the present disclosure relates to apparels for facilitating a lymphatic therapy in relation to a user body.

### BACKGROUND

Compression garments are commonly used to promote circulation, reduce swelling, and manage conditions such as varicose veins or deep vein thrombosis. However, traditional compression wear does not adequately address the growing demand for solutions that support lymphatic health and/or help reduce bloating and fluid retention, especially through comfortable, wearable, and non-invasive means.

Existing designs typically focus on uniform compression and lack integration with technologies that enhance lymphatic flow. Furthermore, many garments on the market are not optimized for continuous wear or do not consider the anatomical structure of the lymphatic system, limiting their therapeutic potential. Accordingly, there exists a need for versatile wearable solutions that combine graduated compression to deliver effective, passive lymphatic support and circulatory stimulation across various zones of the body. Therefore, there is a need for improved apparels for facilitating a lymphatic therapy in relation to a user body.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides an apparel for facilitating a lymphatic therapy in relation to a user body. Further, the apparel may include an apparel layer which may be configured to be positioned on the user body associated with a user. Further, the apparel layer includes a compression layer which may be configured for facilitating a compression of the apparel in relation to the user body. Further, the compression results in the lymphatic therapy in relation to a lymphatic system comprised in the user body. Further, the compression layer further includes a three dimensional pattern which may be configured for facilitating a nano-massage associated with the user body. Further, the nano-massage corresponds to a micro-level stimulation of the user body. Further, the lymphatic therapy may be further based on the nano massage.

The present disclosure provides an apparel for facilitating a lymphatic therapy in relation to a user body. Further, the apparel may include an apparel layer which may be configured to be positioned on the user body associated with a user. Further, the apparel layer includes a compression layer which may be configured for facilitating a compression of the apparel in relation to the user body. Further, the compression results in the lymphatic therapy in relation to a lymphatic system comprised in the user body. Further, the compression layer further includes a three dimensional pattern which may be configured for facilitating a nano-massage associated with the user body. Further, the nano-massage corresponds to a micro-level stimulation of the user body. Further, the lymphatic therapy may be further based on the nano massage. Further, the apparel layer further includes an infrared-radiative layer which may be configured for facilitating emission of an infrared radiation into the user body based on absorbing the heat based on an environment in relation to the apparel. Further, the emitting may be further based on an infrared-radiative material comprised in the infrared-radiative layer. Further, the infrared radiation may be further configured for facilitating the lymphatic therapy.

The present disclosure provides an apparel for facilitating a lymphatic therapy in relation to a user body. Further, the apparel may include an apparel layer which may be configured to be positioned on the user body associated with a user. Further, the apparel layer includes a compression layer which may be configured for facilitating a compression of the apparel in relation to the user body. Further, the compression results in the lymphatic therapy in relation to a lymphatic system comprised in the user body. Further, the compression layer further includes a three dimensional pattern which may be configured for facilitating a nano-massage associated with the user body. Further, the nano-massage corresponds to a micro-level stimulation of the user body. Further, the lymphatic therapy may be further based on the nano massage. Further, the apparel layer further includes a temperature-regulating layer which may be configured for facilitating regulation of a temperature associated with the user body. Further, the regulation may be based on a thermos-regulatory material. Further, the regulation may be further based on a thermos-regulatory property associated with the thermos-regulatory material. Further, the thermos-regulatory property includes one or more of a breathability property and a moisture-wicking property. Further, the breathability property corresponds to an ability of the apparel layer for facilitating a permeability to air. Further, the moisture-wicking property corresponds to the ability of the apparel layer for facilitating each of an extraction of a moisture content from the user body and a dispersion of the moisture content for an accelerated evaporation in relation to an environment.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates frontal view of apparels for facilitating a lymphatic therapy in relation to a user body, in accordance with some embodiments.

FIG. 2 illustrates rear view of apparels for facilitating a lymphatic therapy in relation to a user body, in accordance with some embodiments.

FIG. 3 illustrates an enlarged view of the three-dimensional pattern associated with apparels for facilitating a lymphatic therapy in relation to a user body, in accordance with some embodiments.

FIG. 4 illustrates a compression mark associated with the apparels for facilitating a lymphatic therapy in relation to a user body, in accordance with some embodiments.

FIG. 5 illustrates a lymphatic flow direction in relation to a de-bloating garment associated with apparels for facilitating a lymphatic therapy in relation to a user body, in accordance with some embodiments.

FIG. 6 illustrates an anterior view of lymphatic flow directions in relation to an innerwear associated with apparels for facilitating a lymphatic therapy in relation to a user body, in accordance with some embodiments.

FIG. 7 illustrates a posterior view of lymphatic flow directions in relation to an innerwear associated with apparels for facilitating a lymphatic therapy in relation to a user body, in accordance with some embodiments.

FIG. 8 illustrates lymphatic flow direction in relation to a legging associated with apparels for facilitating a lymphatic therapy in relation to a user body, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

### Overview

The present disclosure relates generally to compression suits and infrared-emitting fabric. Particularly, the present invention is a lymphatic infrared compression full body suit comprising a compression layer, infrared-emitting layer, and a three-dimensional pressure pattern for nano-massage.

In some embodiments, an objective of the present disclosure is to provide a full body compression suit that supports the lymphatic system. The present invention combines a compression layer with a three-dimensional pressure pattern for nano-massage. During use, the three-dimensional pattern utilizes the placement on the user's body to strategically massage the user's body for lymphatic health, enhance blood oxygen levels, and improve circulatory function and sleep quality. By combining acupressure, nano-massage, targeted compression, and infrared-emitting materials within a full body garment, the present invention improves lymphatic flow, aids in detoxification, and supports the relief of cellulite and varicose veins. The present invention provides an antigravity feeling during use, supporting the user while exercising, idle, sleeping, and during daily activities.

In some embodiments, another objective of the present disclosure is to provide a full body compression suit that heats the user's muscles and tissue deeper than existing compression apparel. The present invention utilizes infrared-emitting material to convert the user's natural heat into full-spectrum infrared energy. The infrared energy can penetrate into the user's body during use, heating the user's muscles and tissue. The emitted infrared energy improves blood circulation, increases oxygen levels, and supports better energy, stamina, exercise performance, recovery, rejuvenation, and sleep quality. The present invention may be utilized by all users for daily use or exercise, particularly benefitting athletes, dancers, and similar professions. For example, a ballerina may use the present invention while warming up before performance. An athlete may use the present invention when training to enhance performance or when resting to aid recovery. The present invention can be worn whether the user is moving or idle.

In some embodiments, another objective of the present disclosure is to provide a full body compression suit designed with both safety and aesthetics in mind, utilizing safer materials than existing compression apparel and ensuring a chic appearance that can be worn as a garment for daily use, rest, sleep, or exercise.

In some embodiments, the present disclosure is a lymphatic infrared compression full body suit comprising a compression layer, infrared-emitting layer, and a three-dimensional pressure pattern for nano-massage. The full body design ensures comprehensive body coverage and support.

Further in some embodiments, the unique combination of said compression layer, said infrared-emitting layer, and said three-dimensional pressure pattern optimally placed along the lymphatic system towards lymph nodes optimizes lymphatic health, enhances blood oxygen levels, improves circulatory function, and sleep quality. The present invention improved lymphatic flow, aids in detoxification, and supports the relief of cellulite and varicose veins, resulting in an antigravity effect. The present invention combines acupressure, nano-massage, targeted compression, and infrared-emitting materials within a full body garment.

Further in some embodiments, said three-dimensional pressure pattern provides nano-massage to the user to boost circulation and fluid elimination. During use, said three-dimensional pressure pattern optimally placed along the lymphatic system towards lymph nodes utilizes placement on the user's body to strategically massage the user's body for lymphatic health. The pressure pattern is intended to leave light compression marks on the body to demonstrate the activation of said three-dimensional pattern. These marks are temporary and fade away with approximately an hour of the user not wearing the garment.

In some embodiments, the present disclosure is designed to be stylish and can be implemented throughout a plurality of apparel. Embodiments of the present invention include, but not limited to, high-waisted athletic leggings, tops covering or not covering the arms, full body suits with and without arms, body suits with short length leg length, bodysuit with torso to arm covering, arm sleeves, leg sleeves, legging to upper torso, and more. Throughout the assembly process of the present invention, quality control measures ensure that the present invention meets safety standards, performs as intended, and meets the aesthetic requirements of a wearable fitness, rest, recovery, and sleep garment.

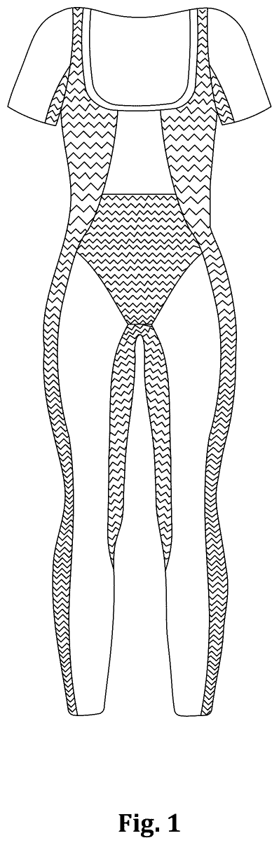

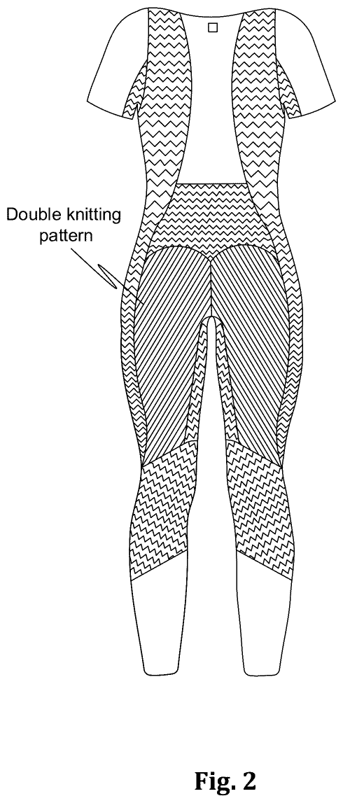

In accordance with FIG. 1 and FIG. 2, the present disclosure is a lymphatic infrared graduated compression full body suit comprising a compression layer, infrared-emitting layer, and a three-dimensional pattern optimally placed along the lymphatic system towards lymph nodes for nano-massage. The full body design ensures comprehensive body coverage and support.

In some embodiments, the said compression layer further comprises a blend of natural, synthetic, and infrared-emitting fibers designed to enhance lymphatic flow. Said graduated compression layer snugly wraps the user's body, applying pressure to promote lymphatic drainage towards the lymph nodes.

In some embodiments, the said infrared-emitting inner layer converts body heat into infrared energy. In the preferred embodiment of the present invention, said inner layer is made from thermos-reactive materials such as bamboo, charcoal, or other mineral-embedded fabrics. Materials are selected by safety, effectiveness, and environmental considerations. Said inner layer utilizes thermos-reactive material to reflect infrared back towards the user's body during use. The present invention utilizes infrared to penetrate heat deep into the user's muscles and tissue during use. As a result, the present invention provides a more therapeutic, effective, and beneficial experience for the wearer, including improved blood circulation, oxygenation, pain recovery, and improved sleep.

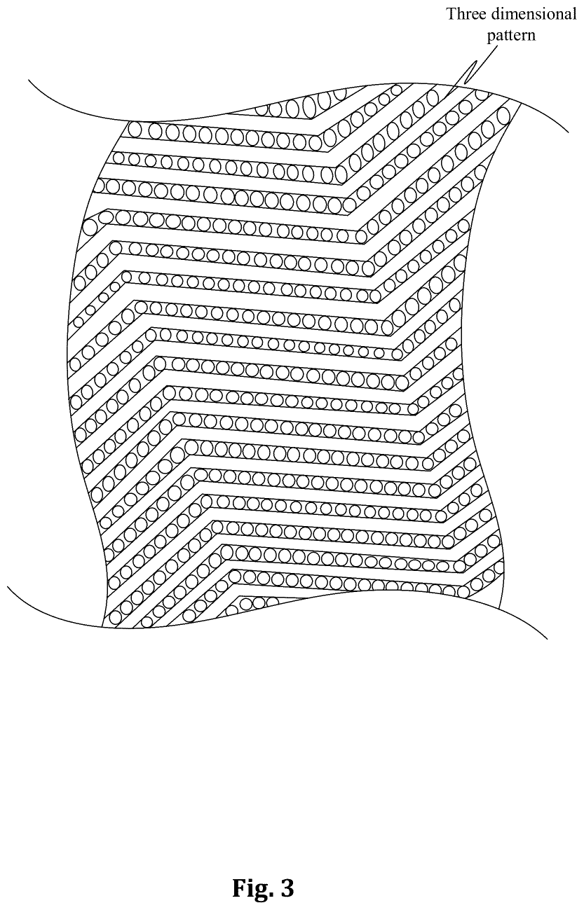

In accordance with FIG. 3, the said three-dimensional pressure pattern provides nano-massage to the user to boost circulation and fluid elimination. During use, said three-dimensional pattern utilizes the movement of the user to strategically massage the user's body for lymphatic health. At key lymphatic points, said three-dimensional pattern comprises a zig zag pattern that is designed to leave a strong impression on the user's skin. In other areas, said three dimensional pattern comprises a double knit pattern.

In some embodiments, the unique combination of said graduated compression layer, said infrared-emitting layer, and said three-dimensional pressure pattern optimizes lymphatic health, enhances blood oxygen levels, and improves circulatory function. The present invention improves lymphatic flow, aids in detoxification, and supports the relief of cellulite and varicose veins. The present invention combines acupressure, nano-massage, targeted compression, and infrared-emitting materials within a full body garment.

In some embodiments, the lymphatic infrared compression full body suit optimizes lymphatic health, enhances blood oxygen levels, and improves circulatory function. it combines acupressure, nano-massage, targeted compression, and infrared-emitting yarn within a full-body garment, making it ideal for both daily wear and athletic use. this suit notably improves lymphatic flow, aids in detoxification, and supports the relief of cellulite and varicose veins.

Further, the suit utilizes a combination of strategically placed compression fabric, a three-dimensional pattern for nano-massage, and infrared-emitting yarn. The compression fabric snugly wraps the body, applying pressure to promote lymphatic drainage towards the lymph nodes. The nano-massage fabric enhances microcirculation and fluid elimination, while the infrared yarn transforms body heat into infrared rays for deep warmth and therapeutic benefits.

In some embodiments, the present disclosure may comprise the following components:
Compression fabric: A blend of natural, synthetic, and IR-emitting fibers designed to enhance lymphatic flow.
Three-dimensional pattern fabric: Provides micro-massage to boost circulation and fluid elimination.
Infrared-emitting yarn: Converts body heat into infrared rays, improving skin and muscle tone and supporting overall lymphatic health.
Full Body Suit Design: Ensures comprehensive body coverage and support.

In some embodiments, the full body suit's assembly involves selecting optimal fiber blends and integrating fir mineral or naturally IR-emitting yarn additives. the fabric is constructed to ensure even distribution of compression and infrared technology, focusing on supporting the lymphatic system effectively. this process includes fabric construction,

sewing, and the incorporation of nano-massage yarn construction, ensuring therapeutic efficacy and comfort.

FIG. 1 illustrates frontal view of apparels for facilitating a lymphatic therapy in relation to a user body, in accordance with some embodiments. Further, the apparel may include a full length body suit.

Accordingly, the apparel may include an apparel layer which may be configured to be positioned on the user body associated with a user. Further, the apparel layer includes a compression layer which may be configured for facilitating a compression of the apparel in relation to the user body. Further, the compression results in the lymphatic therapy in relation to a lymphatic system comprised in the user body. Further, the compression layer further includes a three dimensional pattern which may be configured for facilitating a nano-massage associated with the user body. Further, the nano-massage corresponds to a micro-level stimulation of the user body. Further, the lymphatic therapy may be further based on the nano massage.

FIG. 2 illustrates rear view of apparels for facilitating a lymphatic therapy in relation to a user body, in accordance with some embodiments. Further, the apparel may include a full length body suit.

In some embodiments, the apparel layer further includes an infrared-radiative layer which may be configured for facilitating emission of an infrared radiation into the user body based on absorbing the heat based on an environment in relation to the apparel. Further, the emitting may be further based on an infrared-radiative material comprised in the infrared-radiative layer. Further, the infrared radiation may be further configured for facilitating the lymphatic therapy.

In some embodiments, the lymphatic therapy includes a lymphatic drainage corresponding to a movement of a lymphatic fluid in relation to the lymphatic system.

In some embodiments, the infrared radiation may be configured to penetrate deep into the user body of the user. Further, the infrared radiation may be further configured to facilitate one or more of a pain relief, detoxification, an immune apparel boost, a muscle relief, a stress relief and a better sleep associated with the user body of the user.

In some embodiments, the compression further results in an enhancement in relation to the emission.

In some embodiments, the nano-massage results in an enhancement of one or more of a micro-circulation and a fluid elimination associated with the user body. Further, the micro-circulation corresponds to a blood flow associated with smaller blood vessels. Further, the fluid elimination corresponds to a removal of an excess fluid associated with the user body.

In some embodiments, the three dimensional pattern may be designed to facilitate an optimal positioning of the apparel on a lymphatic node associated with the lymphatic system. Further, the three dimensional pattern may be further configured to facilitate a targeted acupressure during the nano-massage associated with the user body.

In some embodiments, the apparel further facilitates an anti-gravity effect in relation to the user body. Further, the anti-gravity effect corresponds to a sense of lightlessness experienced by the user.

In some embodiments, the apparel may be further associated with an activity performed by the user. Further, the activity includes one or more of a walking, cycling, sleeping, sitting and an exercising. Further, the facilitating of the nano-massage may be further based on the performance of the activity by the user.

FIG. 3 illustrates an enlarged view of the three-dimensional pattern associated with apparels for facilitating a lymphatic therapy in relation to a user body, in accordance with some embodiments.

In some embodiments, the three dimensional pattern includes a knitting pattern corresponding to a pattern of a knit associated with the apparel. Further, the knitting pattern includes a double knitting pattern. Further, the double knitting pattern corresponds to knitting based on a double pattern

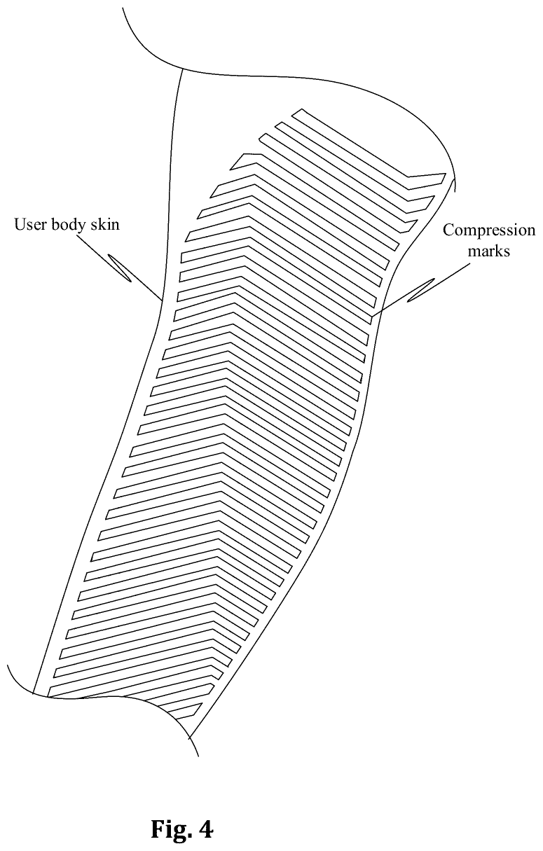

FIG. 4 illustrates a compression mark associated with the apparels for facilitating a lymphatic therapy in relation to a user body, in accordance with some embodiments. Further, the compression marks may be associated with the user body.

In some embodiments, the double knitting pattern may be designed for facilitating a strong imprint of the three dimensional pattern on the user body. Further, the double knitting pattern may be further designed for facilitating resilience in relation to the fabric.

In some embodiments, the apparel layer further includes a temperature-regulating layer which may be configured for facilitating regulation of a temperature associated with the user body. Further, the regulation may be based on a thermos-regulatory material. Further, the regulation may be further based on a thermos-regulatory property associated with the thermos-regulatory material. Further, the thermos-regulatory property includes one or more of a breathability property and a moisture-wicking property. Further, the breathability property corresponds to an ability of the apparel layer for facilitating a permeability to air. Further, the moisture-wicking property corresponds to the ability of the apparel layer for facilitating each of an extraction of a moisture content from the user body and a dispersion of the moisture content for an accelerated evaporation in relation to an environment.

In some embodiments, the thermos-regulatory material includes a thermos-reactive material corresponding to a material which may be configured to change a property based on a temperature variation. Further, the thermos-reactive material includes one or more of a bamboo, a charcoal and a mineral-embedded fabric.

In some embodiments, the infrared radiation facilitates an enhancement of one or more of a blood circulation and an oxygenation level associated with the user body. Further, the apparel layer further includes a sensor device which may be configured for detecting a degree of each of the blood circulation and the lymphatic therapy in relation to the user body. Further, the sensor device includes a biometric sensor device which may be configured for detecting a biometric feedback corresponding to a physiological-activity associated with the user body

In some embodiments, the compression of the apparel in relation to the user body may be further based on an adjustable element corresponding to an element which may be configured to be adjusted based on a compression requirement. Further, the adjustable element includes one or more of an adjustable strap and an adjustable zone associated with the apparel. Further, the detecting may be further based on an AI module. Further, the AI module may be further configured to optimize the adjustable element based on the biometric feedback.

In some embodiments, the infrared-radiant material includes one or more of an infrared emitting yarn comprised the infrared-radiative layer and an enhanced yarn corresponding to a yarn enhanced using an enhancement processes. Further, the enhancement process includes a treatment process associated with the yarn based on one or more of a specialized substance and a dye.

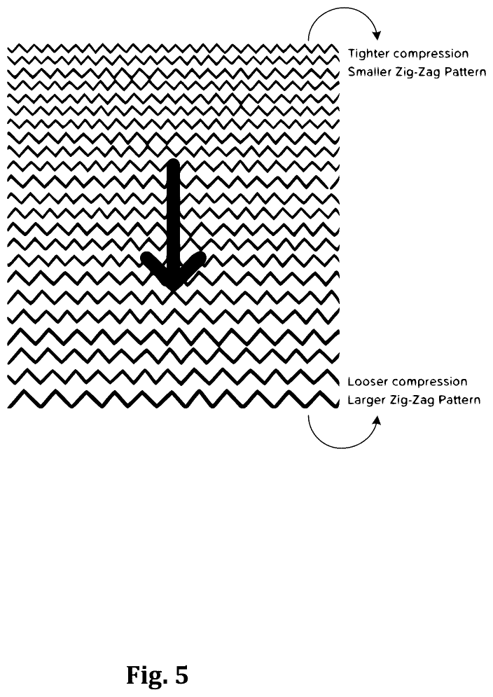

FIG. 5 illustrates a lymphatic flow direction in relation to a de-bloating garment associated with apparels for facilitating a lymphatic therapy in relation to a user body, in accordance with some embodiments.

In some embodiments, the compression includes one or more of a tight compression and a loose compression. Further, the tight compression corresponds to a higher intensity in relation to the compression. Further, the loose compression corresponds to a lower intensity in relation to the compression. Further, the knitting pattern includes a zig-zag knitting pattern corresponding to a zig-zag pattern of the knit associated with the apparel. Further, the zig-zig knitting pattern includes one or more of a small zig-zag pattern and a large zig-zag pattern. Further, the tight compression may be based on the small zig-zag pattern. Further, the loose compression may be based on the large zig-zag pattern.

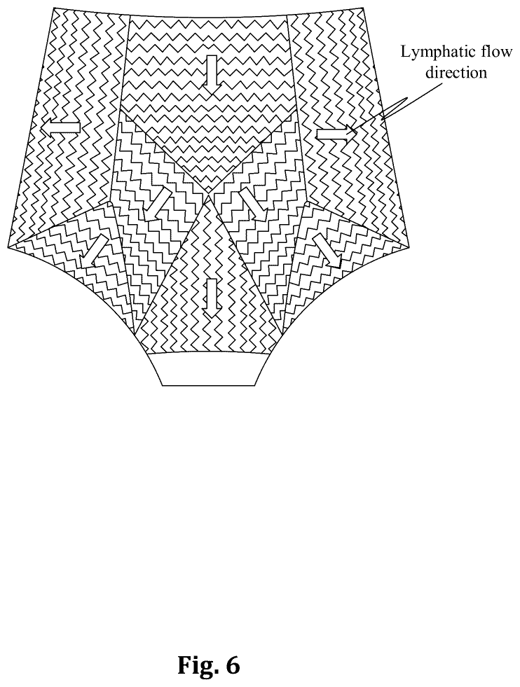

FIG. 6 illustrates an anterior view of lymphatic flow directions in relation to an innerwear associated with apparels for facilitating a lymphatic therapy in relation to a user body, in accordance with some embodiments.

In some embodiments, the movement of the lymphatic fluid may be based on a positioning associated with each of the small zig-zag pattern and the large zig-zag pattern. Further, the movement of the lymphatic fluid may be associated with a movement direction. Further, the movement direction includes a small zig-zag pattern to large zig-zag pattern direction corresponding to the movement of the lymphatic fluid from the small zig-zag pattern to the large zig-zag pattern.

Accordingly, the apparel may include an apparel layer which may be configured to be positioned on the user body associated with a user. Further, the apparel layer includes a compression layer which may be configured for facilitating a compression of the apparel in relation to the user body. Further, the compression results in the lymphatic therapy in relation to a lymphatic system comprised in the user body. Further, the compression layer further includes a three dimensional pattern which may be configured for facilitating a nano-massage associated with the user body. Further, the nano-massage corresponds to a micro-level stimulation of the user body. Further, the lymphatic therapy may be further based on the nano massage. Further, the apparel layer further includes an infrared-radiative layer which may be configured for facilitating emission of an infrared radiation into the user body based on absorbing the heat based on an environment in relation to the apparel. Further, the emitting may be further based on an infrared-radiative material comprised in the infrared-radiative layer. Further, the infrared radiation may be further configured for facilitating the lymphatic therapy.

Accordingly, the apparel may include an apparel layer which may be configured to be positioned on the user body associated with a user. Further, the apparel layer includes a compression layer which may be configured for facilitating a compression of the apparel in relation to the user body. Further, the compression results in the lymphatic therapy in relation to a lymphatic system comprised in the user body. Further, the compression layer further includes a three dimensional pattern which may be configured for facilitating a nano-massage associated with the user body. Further, the nano-massage corresponds to a micro-level stimulation of the user body. Further, the lymphatic therapy may be further based on the nano massage. Further, the apparel layer further includes a temperature-regulating layer which may be configured for facilitating regulation of a temperature associated with the user body. Further, the regulation may be based on a thermos-regulatory material. Further, the regulation may be further based on a thermos-regulatory property associated with the thermos-regulatory material. Further, the thermos-regulatory property includes one or more of a breathability property and a moisture-wicking property. Further, the breathability property corresponds to an ability of the apparel layer for facilitating a permeability to air. Further, the moisture-wicking property corresponds to the ability of the apparel layer for facilitating each of an extraction of a moisture content from the user body and a dispersion of the moisture content for an accelerated evaporation in relation to an environment.

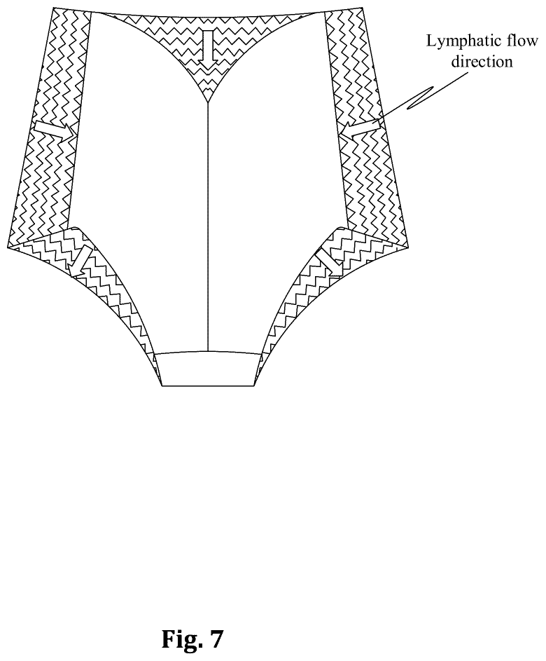

FIG. 7 illustrates a posterior view of lymphatic flow directions in relation to an innerwear associated with apparels for facilitating a lymphatic therapy in relation to a user body, in accordance with some embodiments.

In some embodiments, the apparel includes one or more of a onesie, a high-waisted athletic legging, an innerwear, a top covering an arm, the top not covering the arm, a full body suit with the arm, a full bodysuit without the arm, a body suit with a short leg length, a bodysuit with a torso to arm covering, an arm sleeve and a leg sleeve.

In some embodiments, the anti-gravity effect results in an improved posture of the user body.

In some embodiments, the apparel may be designed to facilitate a relief associated with a medical condition in relation to the user.

In some embodiments, the medical condition includes one or more of a cellulite and a varicose vein.

In some embodiments, the moisture wicking property may be based on a capillarity characteristic associated with the thermos-regulatory material.

In some embodiments, the infrared radiation facilitates a heating in relation to one or more of a muscle and a tissue associated with the user body.

In some embodiments, the user includes one or more of an athlete and a dancer.

In some embodiments, the dancer includes a ballerina. Further, the apparel 300 may be further configured to be worn by the ballerina during a warming-up session associated with the ballerina.

In some embodiments, the apparel may be further configured to be worn by the athlete during a recovery session associated with the athlete.

In some embodiments, the three dimensional pattern may be further configured to leave a compression mark on the user body. Further, the compression mark may be based on an activation in relation to the three dimensional pattern.

In some embodiments, the compression mark may be configured for wearing-out in relation to the user body in a timespan. Further, the timespan includes a one-hour timespan.

In some embodiments, the compression layer includes a blend layer corresponding to a blend of one or more of a natural fiber, a synthetic fiber and an infrared-emitting fiber.

In some embodiments, the optimal positioning of the apparel may be associated with health advantage. Further, the health advantage includes a lymphatic heath advantage.

In some embodiments, the medical condition further includes a lymphatic disorder.

In some embodiments, the lymphatic disorder includes one or more of a lipedema, a lymphedema, a PTOS and a PCOS related swelling.

In some embodiments, the apparel may be configured to facilitate management of a medical-disorder associated with the user body.

In some embodiments, the medical-disorder includes one or more of a post-surgical swelling, a fluid retention and an inflammation.

In some embodiments, the apparel may be further designed to facilitate enhancement of an athletic-engagement factor associated with the athlete.

In some embodiments, the athletic-engagement factor includes one or more of an athletic performance, an athletic recovery and an athletic pre-covery.

In some embodiments, the apparel may be further designed to facilitate a post-partum compression support in relation to the user body.

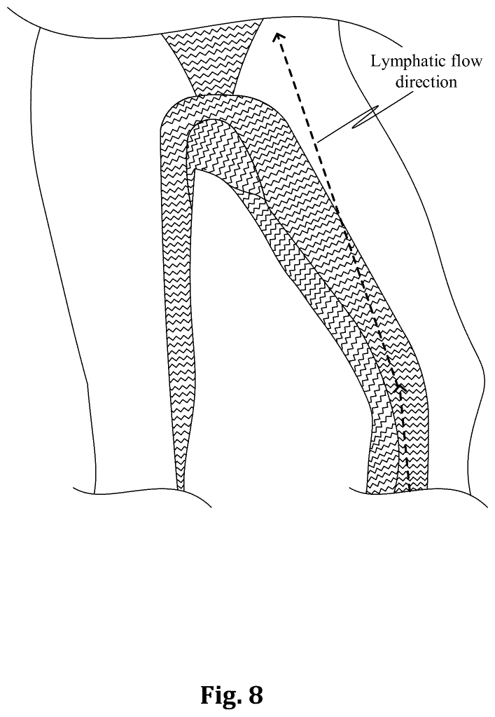

FIG. 8 illustrates lymphatic flow direction in relation to a legging associated with apparels for facilitating a lymphatic therapy in relation to a user body, in accordance with some embodiments.

In some embodiments, the apparel includes a legging. Further, the legging includes each of an ankle-side legging and a hip-side legging. Further, the ankle-side legging may be configured to be positioned on an ankle comprised in the user body. Further, the hip-side legging may be configured to be positioned on a hip comprised in the user body.

In some embodiments, the compression may be further associated with a compression-level corresponding to a level of the compression in relation to the user body. Further, the compression-level includes one or more of a low compression-level and a high compression-level. Further, the movement of the lymphatic fluid may be associated with a movement direction. Further, the movement direction includes a high compression level to low compression-level movement direction corresponding to the movement of the lymphatic fluid from the high compression-level to the low compression-level.

In some embodiments, the ankle-side legging may be associated with the high compression-level. Further, the hip-side legging may be associated with the low compression-level.

In some embodiments, the compression-level may be further associated with a compression-range corresponding to a range in relation to the compression-level. Further, the compression-range in relation to the ankle-side legging includes a five millimeter of mercury to thirty millimeters of mercury range.

In some embodiments, the high compression level to low compression-level movement direction may be associated with a compression-gradient corresponding to a rate-of-change associated with the compression level in relation to the movement of the lymphatic fluid. Further, the compression-gradient includes a zero millimeter of mercury to twenty-five millimeters of mercury gradient.

In some embodiments, the low compression-level may be further associated with a major lymph-node site associated with the lymphatic system comprised in the user body. Further, the major lymph-node site may be configured for facilitating the drainage of the lymphatic fluid.

In some embodiments, the compression-gradient may be configured for preventing a stagnation of the movement associated with the lymphatic fluid in relation to the user body.

In some embodiments, the compression-gradient may be further configured for enhancing one or more of a venous flow and the movement associated with the lymphatic fluid in relation to the user body.

In some embodiments, the compression-gradient may be further configured for facilitating a lymphatic optimization corresponding to an optimization of the lymphatic system comprised in the user body.

In some embodiments, the compression layer may be further configured for facilitating formation of a three dimensional pressure map representing the compression-level in relation to the user body. Further, the three dimensional pressure map may be configured to be positioned on a key-lymphatic drainage pathway associated with the lymphatic system comprised in the user body.

In some embodiments, the three dimensional pressure map may be further configured for facilitating the movement of the lymphatic fluid towards a major lymph node associated with the lymphatic system.

In some embodiments, the major lymph node includes one or more of an inguinal node, an axillary node and a popliteal node.

In some embodiments, the three dimensional pattern may be further associated with a pattern-variation corresponding to a variation associated with the three dimensional pattern in relation to the apparel. Further, the pattern-variation may be designed to facilitate the lymphatic drainage associated with the lymphatic system.

In some embodiments, the pattern-variation may be designed to further facilitate provisioning an optimal support for each of a tissue oxygenation and a tissue recovery.

In some embodiments, the mineral-embedded fabric includes one or more of a CELLIANT fabric and a bio-ceramic fabric.

In some embodiments, the enhancement process further includes a coating process which may be configured for coating the yarn based on an infrared emitting substance.

In some embodiments, the thermos-reactive material includes one or more of a bamboo viscose material, a merino wool material and a eucalyptus-based TENCEL material.

In some embodiments, each of the three dimensional pressure map and the compression-gradient may be configured to facilitate the anti-gravity effect in relation to the user body. Further, the anti-gravity effect may be configured to facilitate one or more of a sense of support and a sense of being energized in relation to the user body.

In some embodiments, the anti-gravity effect may be further configured for counteracting a gravitational pull which may be configured to act on the lymphatic fluid associated with the lymphatic system comprised in the user body. Further, the counteracting results in a mitigation of a lymphatic fluid pooling phenomenon in relation to the user body. Further, the lymphatic fluid pooling phenomenon corresponds to a phenomenon of pooling of the lymphatic fluid in a lower-extremity associated with the user body.

In some embodiments, the apparel may be associated with a durability attribute representing durability of the apparel. Further, the durability attribute includes one or more of a high-stretchability attribute and a shape-retaining attribute associated with the apparel.

In some embodiments, the apparel further includes one or more of a shapewear underwear, a de-bloating garment, a sports bra, a compression top, a bike-shorts and a singlet.

In some embodiments, the environment includes one or more of an external environment in relation to the apparel and the user body associated with the user.

In some embodiments, the de-bloating garment includes a de-bloating underwear.

Although the invention has been explained in relation to its preferred embodiment, it is to be understood that many other possible modifications and variations can be made without departing from the spirit and scope of the invention as hereinafter claimed.

1. An apparel for facilitating a lymphatic therapy in relation to a user body, wherein the apparel comprising:
an apparel layer configured to be positioned on the user body associated with a user, wherein the apparel layer comprises a compression layer configured for facilitating a compression of the apparel in relation to the user body, wherein the compression results in the lymphatic therapy in relation to a lymphatic system comprised in the user body, wherein the compression layer further comprises a three dimensional pattern configured for facilitating a nano-massage associated with the user body, wherein the nano-massage corresponds to a micro-level stimulation of the user body, wherein the lymphatic therapy is further based on the nano massage.

2. The apparel of claim 1, wherein the apparel layer further comprises an infrared-radiative layer configured for facilitating emission of an infrared radiation into the user body based on absorbing the heat based on an environment in relation to the apparel, wherein the emitting is further based on an infrared-radiative material comprised in the infrared-radiative layer, wherein the infrared radiation is further configured for facilitating the lymphatic therapy.

3. The apparel of claim 1, wherein the lymphatic therapy comprises a lymphatic drainage corresponding to a movement of a lymphatic fluid in relation to the lymphatic system.

4. The apparel of claim 2, wherein the infrared radiation is configured to penetrate deep into the user body of the user, wherein the infrared radiation is further configured to facilitate at least one of a pain relief, detoxification, an immune apparel boost, a muscle relief, a stress relief and a better sleep associated with the user body of the user.

5. The apparel of claim 2, wherein the compression further results in an enhancement in relation to the emission.

6. The apparel of claim 1, wherein the nano-massage results in an enhancement of at least one of a micro-circulation and a fluid elimination associated with the user body, wherein the micro-circulation corresponds to a blood flow associated with smaller blood vessels, wherein the fluid elimination corresponds to a removal of an excess fluid associated with the user body.

7. The apparel of claim 1, wherein the three dimensional pattern is designed to facilitate an optimal positioning of the apparel on a lymphatic node associated with the lymphatic system, wherein the three dimensional pattern is further configured to facilitate a targeted acupressure during the nano-massage associated with the user body.

8. The apparel of claim 1, wherein the apparel further facilitates an anti-gravity effect in relation to the user body, wherein the anti-gravity effect corresponds to a sense of lightlessness experienced by the user.

9. The apparel of claim 1, wherein the apparel is further associated with an activity performed by the user, wherein the activity comprises at least one of walking, cycling, sleeping, sitting and exercising, wherein the facilitating of the nano-massage is further based on the performance of the activity by the user.

10. The apparel of claim 3, wherein the three dimensional pattern comprises a knitting pattern corresponding to a pattern of a knit associated with the apparel, wherein the knitting pattern comprises a double knitting pattern, wherein the double knitting pattern corresponds to knitting based on a double pattern

11. The apparel of claim 10, wherein the double knitting pattern is designed for facilitating a strong imprint of the three dimensional pattern on the user body, wherein the double knitting pattern is further designed for facilitating resilience in relation to the fabric.

12. The apparel of claim 1, wherein the apparel layer further comprises a temperature-regulating layer configured for facilitating regulation of a temperature associated with the user body, wherein the regulation is based on a thermos-regulatory material, wherein the regulation is further based on a thermos-regulatory property associated with the thermos-regulatory material, wherein the thermos-regulatory property comprises at least one of a breathability property and a moisture-wicking property, wherein the breathability property corresponds to an ability of the apparel layer for facilitating a permeability to air, wherein the moisture-wicking property corresponds to the ability of the apparel layer for facilitating each of an extraction of a moisture content from the user body and a dispersion of the moisture content for an accelerated evaporation in relation to an environment.

13. The apparel of claim 12, wherein the thermos-regulatory material comprises a thermos-reactive material corresponding to a material configured to change a property based on a temperature variation, wherein the thermos-reactive material comprises at least one of a bamboo, a charcoal and a mineral-embedded fabric.

14. The apparel of claim 2, wherein the infrared radiation facilitates an enhancement of at least one of a blood circulation and an oxygenation level associated with the user body, wherein the apparel layer further comprises a sensor device configured for detecting a degree of each of the blood circulation and the lymphatic therapy in relation to the user body, wherein the sensor device comprises a biometric sensor device configured for detecting a biometric feedback corresponding to a physiological-activity associated with the user body

15. The apparel of claim 14, wherein the compression of the apparel in relation to the user body is further based on an adjustable element corresponding to an element configured to be adjusted based on a compression requirement, wherein the adjustable element comprises at least one of an adjustable strap and an adjustable zone associated with the apparel, wherein the detecting is further based on an AI module, wherein the AI module is further configured to optimize the adjustable element based on the biometric feedback.

16. The apparel of claim 2, wherein the infrared-radiant material comprises at least one of an infrared emitting yarn comprised the infrared-radiative layer and an enhanced yarn corresponding to a yarn enhanced using an enhancement processes, wherein the enhancement process comprises a treatment process associated with the yarn based on at least one of a specialized substance and a dye.

17. The apparel of claim 10, wherein the compression comprises at least one of a tight compression and a loose compression, wherein the tight compression corresponds to a higher intensity in relation to the compression, wherein the loose compression corresponds to a lower intensity in relation to the compression, wherein the knitting pattern comprises a zig-zag knitting pattern corresponding to a zig-zag pattern of the knit associated with the apparel, wherein the zig-zig knitting pattern comprises at least one of a small zig-zag pattern and a large zig-zag pattern, wherein the tight compression is based on the small zig-zag pattern, wherein the loose compression is based on the large zig-zag pattern.

18. The apparel of claim 17, wherein the movement of the lymphatic fluid is based on a positioning associated with each of the small zig-zag pattern and the large zig-zag pattern, wherein the movement of the lymphatic fluid is associated with a movement direction, wherein the movement direction comprises a small zig-zag pattern to large zig-zag pattern direction corresponding to the movement of the lymphatic fluid from the small zig-zag pattern to the large zig-zag pattern.

19. An apparel for facilitating a lymphatic therapy in relation to a user body, wherein the apparel comprising:
an apparel layer configured to be positioned on the user body associated with a user, wherein the apparel layer comprises a compression layer configured for facilitating a compression of the apparel in relation to the user body, wherein the compression results in the lymphatic therapy in relation to a lymphatic system comprised in the user body, wherein the compression layer further comprises a three dimensional pattern configured for facilitating a nano-massage associated with the user body, wherein the nano-massage corresponds to a micro-level stimulation of the user body, wherein the lymphatic therapy is further based on the nano massage, wherein the apparel layer further comprises an infrared-radiative layer configured for facilitating emission of an infrared radiation into the user body based on absorbing the heat based on an environment in relation to the apparel, wherein the emitting is further based on an infrared-radiative material comprised in the infrared-radiative layer, wherein the infrared radiation is further configured for facilitating the lymphatic therapy.

20. An apparel for facilitating a lymphatic therapy in relation to a user body, wherein the apparel comprising:
an apparel layer configured to be positioned on the user body associated with a user, wherein the apparel layer comprises a compression layer configured for facilitating a compression of the apparel in relation to the user body, wherein the compression results in the lymphatic therapy in relation to a lymphatic system comprised in the user body, wherein the compression layer further comprises a three dimensional pattern configured for facilitating a nano-massage associated with the user body, wherein the nano-massage corresponds to a micro-level stimulation of the user body, wherein the lymphatic therapy is further based on the nano massage, wherein the apparel layer further comprises a temperature-regulating layer configured for facilitating regulation of a temperature associated with the user body, wherein the regulation is based on a thermos-regulatory material, wherein the regulation is further based on a thermos-regulatory property associated with the thermos-regulatory material, wherein the thermos-regulatory property comprises at least one of a breathability property and a moisture-wicking property, wherein the breathability property corresponds to an ability of the apparel layer for facilitating a permeability to air, wherein the moisture-wicking property corresponds to the ability of the apparel layer for facilitating each of an extraction of a moisture content from the user body and a dispersion of the moisture content for an accelerated evaporation in relation to an environment.
